(19) United States
(12) Patent Application Publication
(10) Pub. No.: US 2019/0196239 A1
(43) Pub. Date: Jun. 27, 2019

(54) PIXEL STRUCTURE, DISPLAY PANEL AND DRIVING METHOD

(71) Applicants: FUZHOU BOE OPTOELECTRONICS TECHNOLOGY CO., LTD., Fujian (CN); BOE TECHNOLOGY GROUP CO., LTD., Beijing (CN)

(72) Inventors: Jie Liu, Beijing (CN); Kai Diao, Beijing (CN); Hongyu Zhao, Beijing (CN); Zongjie Bao, Beijing (CN); Han Zhang, Beijing (CN)

(21) Appl. No.: 16/328,177

(22) PCT Filed: Jun. 1, 2018
(86) PCT No.: PCT/CN2018/089602

§ 371 Date: Feb. 25, 2019

(30) Foreign Application Priority Data
Jun. 7, 2017 (CN) 201710423305.7

(51) Int. Cl. G02F 1/1368; G02F 1/1362; G09G 3/36

(52) U.S. Cl. CPC G02F 1/1368; G02F 1/136209; G09G 2300/0426; G02F 2001/136222; G09G 2300/0465; G09G 3/3648

(57) ABSTRACT

A pixel structure, a display panel and a driving method are provided. The pixel structure is used for a display panel and includes a first substrate and a second substrate, the pixel structure further includes a light blocking switching member that covers an opening region of the pixel structure, the light blocking switching member is configured to switch between a first state and a second state, in the first state, light is allowed to pass through the light blocking switching member so as to enter the opening region; and in the second state, the opening region of the pixel structure is shielded by the light blocking switching member.

### CROSS-REFERENCE TO RELATED APPLICATION

This application is a Section 371 National Stage Application of International Application No. PCT/CN2018/089602, filed on Jun. 1, 2018. This application claims the benefit of Chinese Patent Application No. 201710423305.7 filed on Jun. 7, 2017 in the State Intellectual Property Office of China, the disclosures of which are incorporated herein by reference.

### TECHNICAL FIELD

The present disclosure relates to the field of display technology, and in particular, to a pixel structure, a display panel and a driving method.

### BACKGROUND

LCD (Liquid Crystal Display) is widely used due to its advantageous properties such as thin thickness, low radiation, and low power consumption. Liquid crystal molecules change their molecular arrangement under the action of an electric field, and thus different transmittances may be produced. Liquid crystal displays use the characteristic of the liquid crystal molecules to produce display effects.

### SUMMARY

An embodiment of the present disclosure provides a pixel structure comprising a first substrate and a second substrate, the pixel structure being used for a display panel, the pixel structure further comprises a light blocking switching member that covers an opening region of the pixel structure, the light blocking switching member is configured to switch between a first state and a second state, such that in the first state, light is allowed to pass through the light blocking switching member so as to enter the opening region, and in the second state, the opening region of the pixel structure is shielded by the light blocking switching member.

In some embodiments, the light blocking switching member is configured to be in the first state in response to a non-dark state of the display panel, and to be in the second state in response to a dark state of the display panel.

In some embodiments, the light blocking switching member switches between the first state and the second state by applying a voltage to the light blocking switching member.

In some embodiments, the light blocking switching member comprises an electronic ink and a package device, the package device comprising a first electrode and a second electrode spaced apart from each other in a direction parallel to the first substrate or the second substrate, and the electronic ink being encapsulated within the package device and disposed between the first electrode and the second electrode, the electronic ink is capable of changing position within the package device under the action of a voltage applied between the first electrode and the second electrode.

In some embodiments, wherein the light blocking switching member switches between the first state and the second state by applying the voltage between the first electrode and the second electrode, wherein in the first state, the electronic ink is collected at an edge of the package device such that an orthographic projection of the electronic ink on the first substrate or the second substrate is smaller than an orthographic projection of an inner surface of the package device parallel to the first substrate or the second substrate on the first substrate or the second substrate, and in the second state, the electronic ink is dispersed within the package device in a direction parallel to the first substrate or the second substrate in a such that the orthographic projection of the electronic ink on the first substrate or the second substrate coincides with the orthographic projection of an inner surface of the package device parallel to the first substrate or the second substrate on the first substrate or the second substrate.

In some embodiments, the package device further comprises a third electrode and a fourth electrode spaced apart from each other in a direction perpendicular to the first substrate or the second substrate; the light blocking switching member is configured such that, in a process of switching from the first state to the second state, the electronic ink is evenly distributed on the inner surface of the package device parallel to the first substrate or the second substrate by applying a voltage between the third electrode and the fourth electrode.

In some embodiments, the package device further comprises a third electrode and a fourth electrode spaced apart from each other in a direction perpendicular to the first substrate or the second substrate; the light blocking switching member is configured such that, in a process of switching from the first state to the second state, a voltage applied between the third electrode and the fourth electrode is zero.

In some embodiments, the pixel structure further comprising a liquid crystal layer between the first substrate and the second substrate, and a black matrix on a side of the first substrate adjacent to the liquid crystal layer;

wherein the electronic ink is collected in a region within the package device corresponding to the black matrix in the first state.

In some embodiments, both the third electrode and the fourth electrode are transparent electrodes.

In some embodiments, the second substrate further comprises a base substrate and a thin film transistor, the light blocking switching member being located between the thin film transistor and the base substrate.

In some embodiments, a color filter is provided on a region of the first substrate corresponding to the opening region of the pixel structure.

In some embodiments, the electronic ink comprises a plurality of charged particles with the same electric property.

In some embodiments, the electronic ink comprises a black and opaque ink.

An embodiment of the present disclosure provides a display panel comprising a plurality of the pixel structures as described above.

An embodiment of the present disclosure provides a driving method for driving the pixel structure as described above, comprising: switching light blocking switching member to the first state in response to a non-dark state of the display panel; switching the light blocking switching member to the second state in response to a dark state of the display panel.

In some embodiments, a voltage is applied to the light blocking switching member such that the light blocking switching member switches between the first state and the second state.

In some embodiments, the light blocking switching member comprises an electronic ink and a package device, the package device comprising a first electrode and a second electrode spaced apart from each other in a direction parallel to the first substrate or the second substrate, and the electronic ink being encapsulated within the package device and disposed between the first electrode and the second electrode, the voltage is applied between the first electrode and the second electrode such that the light blocking switching member switches between the first state and the and the second state, wherein in the first state, the electronic ink is collected at an edge of the package device such that an orthographic projection of the electronic ink on the first substrate or the second substrate is smaller than an orthographic projection of an inner surface of the package device parallel to the first substrate or the second substrate on the first substrate or the second substrate, and in the second state, the electronic ink is distributed in the package device in a direction parallel to the first substrate or the second substrate such that the orthographic projection of the electronic ink on the first substrate or the second substrate coincides with the orthographic projection of the inner surface of the package device parallel to the first substrate or the second substrate on the first substrate or the second substrate.

In some embodiments, the package device further comprises a third electrode and a fourth electrode spaced apart from each other in a direction perpendicular to the first substrate or the second substrate, and in a process of switching the light blocking switching member from the first state to the second state, the electronic ink is evenly distributed on an inner surface of the package device parallel to the first substrate or the second substrate by applying a voltage between the third electrode and the fourth electrode.

### BRIEF DESCRIPTION OF THE DRAWINGS

FIG. 1 is a schematic structural view of a pixel structure;

FIG. 2 is a schematic view of a pixel structure when a display panel is in a non-dark state according to an embodiment of the present disclosure;

FIG. 3 is a schematic view of a pixel structure when a display panel is in a dark state according to an embodiment of the present disclosure.

### DETAILED DESCRIPTION OF THE EMBODIMENTS

The technical solutions in the present disclosure will be clearly and completely described below in conjunction with the drawings in the present disclosure. It is obvious that the described embodiments are a part of the embodiments of the present disclosure, and not all of the embodiments. All other embodiments obtained by a person of ordinary skill in the art based on the embodiments of the present disclosure without creative efforts are within the scope of the present disclosure.

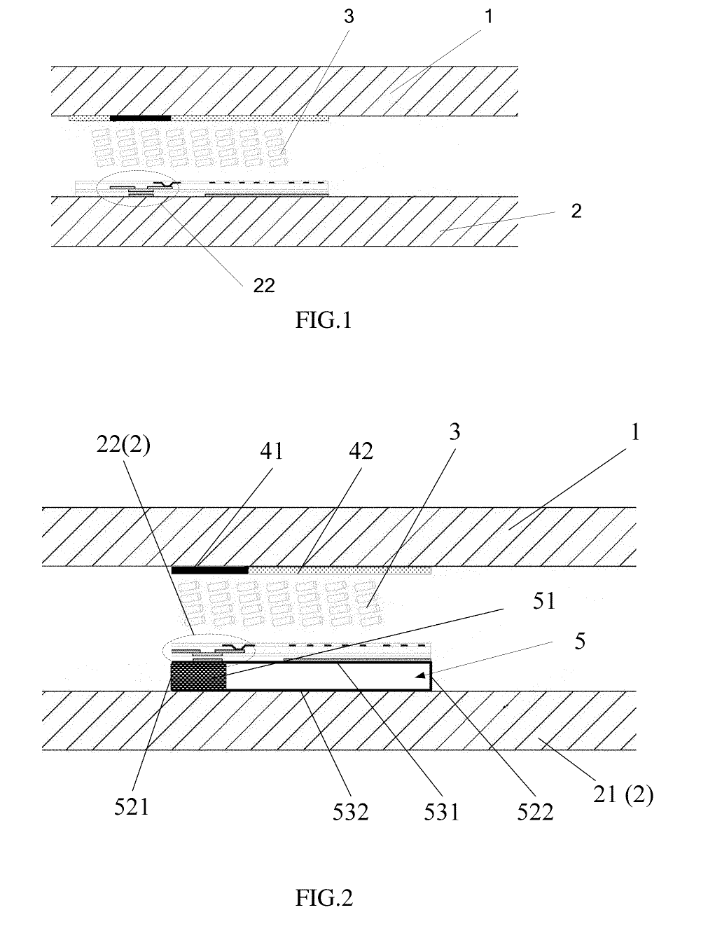

An LCD (Liquid Crystal Display) includes a backlight and a plurality of pixel structures arranged in an array. As shown in FIG. 1, the pixel structure includes a first substrate 1 and a second substrate 2. A liquid crystal layer 3 is disposed between the first substrate and the second substrate, a transistor 22 is disposed on the second substrate, and a color filter with corresponding color is disposed at a position of the first substrate corresponding to the pixel structure. Whether it is ADS (Advanced Super Dimension Switching) display mode and IPS (In-Plane Switching) display mode, or TN (Twisted Nematic) display mode and VA (Vertical The Alignment type) display mode, image display is realized by utilizing the optical rotation characteristics of the liquid crystal molecules in the liquid crystal layer 3 cooperated with upper and lower polarizing plates. That is, by controlling the signals and voltages applied to the respective thin film transistors 22, a direction of rotation of the liquid crystal molecules is controlled, thereby controlling the emission of polarized light of each pixel for display purposes.

When a dark state image is displayed, the backlight is prone to a light leakage. Especially in the ADS and IPS display modes, a dark state light leakage is a common phenomenon, which affects the display effect and reduces the image quality.

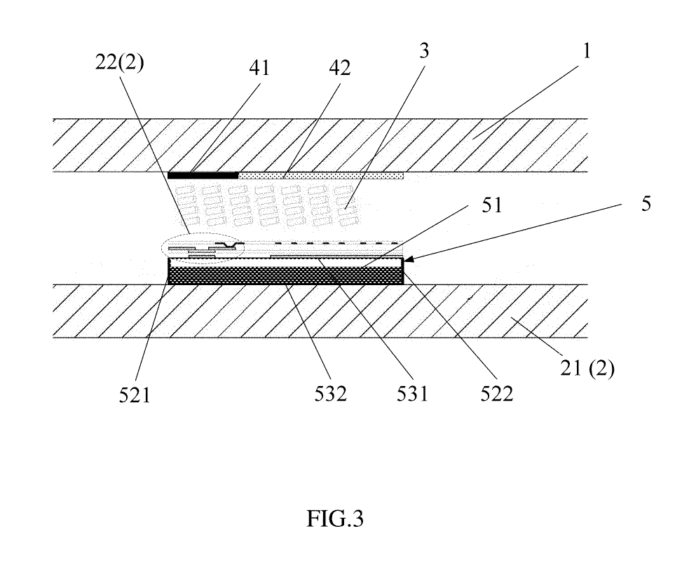

Embodiments of the present disclosure provide a pixel structure, a display panel, and a driving method for at least partially solving the problem of dark state light leakage of a liquid crystal display panel. Referring to FIG. 2 and FIG. 3, an embodiment of the present disclosure provides a pixel structure, FIG. 2 is a schematic view of the pixel structure when a display panel is in a non-dark state, and FIG. 3 is a schematic view of the pixel structure when a display panel is in a dark state.

The pixel structure includes a first substrate 1 and a second substrate 2, and the second substrate 2 is an array substrate including a base substrate 21 and a thin film transistor 22 formed on the base substrate 21. The pixel structure further includes a light blocking switching member 5. The light blocking switching member 5 covers an opening region of the pixel structure. The light blocking switching member 5 may switch between a first state and a second state. In the first state, light is allowed to pass through the light blocking switching member 5 so as to enter the opening region, and in the second state, the opening region of the pixel structure is shielded by the light blocking switching member 5. The pixel structure may be an R sub-pixel, a G sub-pixel, or a B sub-pixel.

The pixel structure of the embodiment of the present disclosure includes a first substrate 1, a second substrate 2, and a light blocking switching member 5, and the light blocking switching member 5 covers an opening region of the pixel structure. The light blocking switching member is in the first state when a display panel comprising the pixel structure is in a non-dark state, so that the display panel may display normally. The light blocking switching member 5 is in the second state and may completely shield the opening region of the pixel structure when the display panel is in a dark state, so that the light does not exit from the first substrate, thereby effectively solving the problem of dark state light leakage of the display panel.

The specific structure of the light blocking switching member 5 will be described in detail below with reference to FIGS. 2 and 3.

As shown in FIGS. 2 and 3, the light blocking switching member 5 includes an electronic ink 51 and a package device, the package device includes a first group of electrodes including a first electrode 521 and a second electrode 522 disposed perpendicular to the first substrate 1. An accommodating space for encapsulating the electronic ink 51 is formed between the first electrode and the second electrode, and the electronic ink 51 may change positions in the accommodating space under an action of an electric field. As shown in FIGS. 2 and 3, the first electrode 521 and the second electrode 522 are respectively located at opposite ends of the package device (or the light blocking switching member), and are spaced apart from each other in a direction parallel to the first substrate 1 or the second substrate 2. The electronic ink 51 may change positions in the accommodating space, so that the electronic ink 51 can be collected at an edge of the accommodating space, for example, the edge close to the first electrode 521. In this case, an orthographic projection of the electronic ink 51 on the first substrate 1 or the second substrate 2 is smaller than an orthographic projection of the accommodating space on the first substrate 1 or the second substrate 2. Alternatively, the electronic ink 51 may be distributed on an entire plane within the accommodating space parallel to the first substrate 1 or the second substrate 2, such that the orthographic projection of the electronic ink 51 on the first substrate 1 or the second substrate 2 coincides with the orthographic projection of the accommodating space on the first substrate 1 or the second substrate 2.

As shown in FIG. 3, the light blocking switching member 5 is specifically configured to control the electronic ink 51 to fill the accommodating space in a direction parallel to the second substrate 2 according to a voltage applied between the first electrode 521 and the second electrode 522 when the display panel is switched from the non-dark state to the dark state. That is, the electronic ink 51 fills the accommodating space in a direction perpendicular to the first electrode and the second electrode.

A voltage is formed between the first electrode 521 and the second electrode 522 to form an electric field in the horizontal direction in the package device, and the flow direction of the electronic ink 51 is related to the direction of the electric field and the positive/negative polarities of charged particles in the electronic ink 51. If a potential applied to the first electrode 521 is less than a potential applied to the second electrode 522, the direction of the electric field is a direction in which the second electrode 522 is directed to the first electrode 521, and if the charged particles in the electronic ink 51 are negative particles, the negative particles are attracted by the second electrode 522, so that the electronic ink 51 flows in the direction towards the second electrode 522 (in this case, the flow direction of the electronic ink 51 is opposite to the direction of the electric field). If the potential applied to the first electrode 521 is greater than the potential applied to the second electrode 522, the direction of the electric field is a direction in which the first electrode 521 is directed to the second electrode 522, and if the charged particles in the electronic ink 51 are positive particles, the positive particles are attracted by the second electrode 522, the electronic ink 51 flows in the direction towards the second electrode 522 (in this case, the flow direction of the electronic ink 51 is the same as the direction of the electric field).

The electronic ink 51 is black and opaque, and it may be an electrophoretic ink. The electrophoretic ink includes a plurality of charged particles of the same electric property. The accommodating space is filled with an insulating medium, and the charged particles are suspended in the insulating medium, and the charged particles may move in the insulating medium under the action of an electric field. After the electric field disappears, the charged particles may maintain their position in the insulating medium, that is, the electronic ink remains in a certain state. When the display panel is switched from the non-dark state to the dark state, a voltage is applied between the first electrode 521 and the second electrode 522, and the electronic ink 51 is in an electric field. If the direction of the electric field is the direction in which the second electrode 522 is directed to the first electrode 521, and the charged particles in the electronic ink 51 are negative particles; or the direction of the electric field is the direction in which the first electrode 521 is directed to the second electrode 522, and the charged particles in the electronic ink 51 are positive particles, the charged particles flow towards the second electrode 522 under the action of the electric field until the electronic ink 51 is spread to form an ink layer having a large footprint. In this case, the area shielded by the electronic ink 51 also becomes large, the electronic ink fills the accommodating space in the direction parallel to the second substrate 2. The voltage applied between the first electrode 521 and the second electrode 522 is then set to 0, and the electronic ink remains in the tiled ink layer state.

Further, the package device further includes a second group of electrodes, and the second group of electrodes includes a third electrode 531 and a fourth electrode 532 disposed parallel to the first substrate 1. The first electrode 521, the second electrode 522, the third electrode 531 and the fourth electrode 532 form a hollow structure having a rectangular shape as the above-described accommodation space. As shown in FIGS. 2 and 3, the third electrode 531 and the fourth electrode 532 are respectively located at opposite ends of the package device (or the light blocking switching member), and are spaced apart from each other in a direction perpendicular to the first substrate 1 or the second substrate 2.

The light blocking switching member 5 is further configured to control the electronic ink 51 to uniformly fill the accommodating space in the direction parallel to the second substrate 2 according to a voltage applied between the first electrode 521 and the second electrode 522 and a voltage applied between the third electrode 531 and the fourth electrode 532 when the display panel is switched from the non-dark state to the dark state. That is, when the display panel is switched from the non-dark state to the dark state, a voltage is provided between the first electrode 521 and the second electrode 522 to form an electric field in the horizontal direction, and a voltage is also provided between the third electrode 531 and the fourth electrode 532 to form an electric field in the vertical direction.

It should be noted that the magnitude of the voltage between the third electrode 531 and the fourth electrode 532 is also determined by the placement of the display panel. If the display panel and the pixel structure are placed in the states shown in FIGS. 2 and 3, when the display panel is switched from the non-dark state to the dark state, for the electronic ink 51 containing the negative particles, a potential applied to the third electrode 531 adjacent to the thin film transistor 22 is greater than a potential applied to the fourth electrode 532 adjacent to the base substrate 21; and for the electronic ink 51 containing the positive particles, the potential applied to the third electrode 531 adjacent to the thin film transistor 22 is less than the potential applied to the fourth electrode 532 adjacent to the base substrate 21. Thus, the electronic ink 51 may flow in a direction toward the third electrode 531, so that the electronic ink 51 is uniformly diffused in an inner surface the package device parallel to the first substrate or the second substrate, for example, in the upper inner surface, thereby ensuring the light blocking effect.

It should be noted that, as shown in FIG. 2 and FIG. 3, the pixel structure may further include a liquid crystal layer 3 disposed between the first substrate 1 and the second substrate 2. A black matrix 41 is provided on a side of the first substrate 1 adjacent the liquid crystal layer 3. The black matrix 41 is arranged in a grid shape, and the grid-like black matrix 41 and a thin film transistor 22 form an opening region of the pixel structure. A color filter 42 is provided in a region of the first substrate 1 corresponding to the opening region. The color filter 42 may be an R/G/B color filter, and the corresponding pixel structure is an R sub-pixel, a G sub-pixel, or a B sub-pixel that matches the R/G/B color filter. An orthographic projection of the first electrode 521 on the first substrate 1 is aligned with an orthographic projection of an edge of the black matrix 41 away from the color filter 42 on the first substrate 1, and an orthographic projection of the second electrode 522 on the first substrate 1 is aligned with an orthographic projection of an edge of the color filter 42 away from the black matrix 41 on the first substrate 1.

Further, as shown in FIG. 2, the electronic ink 51 in the light blocking switching member 5 is collected in a region of the accommodating space corresponding to the black matrix 41 when the display panel is in the non-dark state.

When the display panel is switched from the dark state to the non-dark state, if the potential applied to the first electrode 521 is greater than the potential applied to the second electrode 522, the direction of the electric field is the direction in which the first electrode 521 is directed to the second electrode 522, and if the charged particles in the electronic ink 51 are negative particles, the negative particles are attracted by the first electrode 521 so that the electronic ink 51 flows in the direction towards the first electrode 521 (in this case, the flow direction of the electronic ink 51 is opposite to the direction of the electric field). If the potential applied to the first electrode 521 is less than the potential applied to the second electrode 522, the direction of the electric field is the direction in which the second electrode 522 is directed to the first electrode 521, and if the charged particles in the electronic ink 51 are positive particles, the positive particles are attracted by the first electrode 521, the electronic ink 51 flows in the direction towards the first electrode 521 (in this case, the flow direction of the electronic ink 51 is the same as the direction of the electric field). In this case, a voltage is applied between the first electrode 521 and the second electrode 522 until the electronic ink 51 is collected in the direction towards the first electrode 521 to form an ink droplet having a large thickness and a small footprint (located in the region of the accommodating space corresponding to the black matrix 41). In this case, the area shielded by the electronic ink 51 is the region corresponding to the black matrix 41, and the electronic ink 51 no longer shields the opening region of the pixel structure (i.e., the region corresponding to the color filter 42). The voltage applied between the first electrode 521 and the second electrode 522 is then set to 0, and the electronic ink remains in the ink drop state.

It should be noted that since the black matrix 41 needs to shield the thin film transistor 22, the black matrix 41 without a portion thereof corresponding to the thin film transistor 22 has a strip shape in the pixel structure, and the portion of the black matrix 41 corresponding to the thin film transistor 22 has a block shape. Thus, the black matrix 41 has different widths. When the display panel is in a non-dark state, the electronic ink 51 may be collected in a region of the accommodation space corresponding to the minimum width of the black matrix 41 (i.e., a region corresponding to the strip portion of the black matrix 41), thereby increasing the aperture ratio. When the display panel is switched from the dark state to the non-dark state, the voltage applied between the third electrode 531 and the fourth electrode 532 may be zero, or there is no need to apply a voltage between the third electrode 531 and the fourth electrode 532. Thus, the electronic ink 51 does not flow in a direction perpendicular to the second substrate 2, and the aperture ratio may not be affected.

When the display panel is in the non-dark state, the electronic ink 51 may also be collected in a region of the accommodation space corresponding to the maximum width of the black matrix 41 (i.e., a region corresponding to the block portion of the black matrix 41), The width of the region is at least equal to the width of the thin film transistor 22. In this case, the electronic ink 51 can function as a black matrix. Of course, those skilled in the art can know that if the black matrix 41 is already disposed on the first substrate 1, the electronic ink 51 can also be collected in the region of the accommodating space corresponding to the minimum width of the black matrix 41 when the display panel is in the non-dark state (that is, the thin film transistor 22 needs not be shielded). In this way, the aperture ratio is larger and the display effect is better.

Optionally, the third electrode 531 and the fourth electrode 532 are transparent electrodes, so that when the display panel is in the non-dark state, the third electrode 531 and the fourth electrode 532 can transmit light without affecting the normal display of the pixel structure.

Optionally, material of the third electrode 531 and the fourth electrode 532 may be ITO (Indium tin oxide).

The light blocking switching member 5 may be disposed on the first substrate 1, for example, disposed on a side, adjacent to the liquid crystal layer 3, of the black matrix 41 and the color filter 42 on the first substrate 1, or disposed between the black matrix 41/the color filter 42 and the first substrate 1. The light blocking switching member 5 may be disposed on the second substrate 2, for example, disposed on a side of each of the thin film transistors 22 of the second substrate 2 adjacent to the liquid crystal layer 3, or may be disposed between each of the thin film transistors 22 and the base substrate 21.

Since wires connected to the thin film transistor, such as repairing wires, driving wires, and the like are all disposed on the second substrate 2, in order to simplify the layout of wires connected to the first electrode 521, the second electrode 522, the third electrode 531, and the fourth electrode 532 of the light blocking switching member 5, In the embodiment of the present disclosure, the light blocking switching member 5 is located on the second substrate 2, optionally, located between the thin film transistor 22 and the substrate 21.

Embodiments of the present disclosure also provide a display panel that includes the pixel structure as previously described. The structure of the pixel structure is as described above, and will not be described herein.

It should be noted that the display panel is a liquid crystal display panel, and includes a first substrate and a second substrate, wherein the second substrate 2 is an array substrate. As shown in FIGS. 2 and 3, the second substrate 2 includes a base substrate 21 and a thin film transistor 22, and the thin film transistor 22 is disposed on the base substrate 21.

The ADS mode display panel and the IPS mode display panel are more are more prone to the problem of dark state light leakage due to characteristics of display modes. Therefore, optionally, the display panel may be an ADS mode liquid crystal display panel or an IPS mode liquid crystal display panel.

In the display panel of the embodiment of the present disclosure, the light blocking switching member 5 is disposed in the pixel structure, the light blocking switching member 5 may completely shield the opening region of the pixel structure according to the voltage applied thereto when the display panel is in the dark state, such that light does not exit from the first substrate. Even if the display panel is subjected to an external force, the liquid crystal molecules change the alignment state, the light does not exit from the first substrate since the light blocking switching member 5 shields the opening region, thereby effectively solving the problem of dark state light leakage of the display panel.

As shown in FIG. 2 and FIG. 3, an embodiment of the present disclosure further provides a driving method for driving the pixel structure as described above, the method includes:

A first voltage is applied to the light blocking switching member 5, so that the display panel is switched from a non-dark state to a dark state, the light blocking switching member 5 may completely shield the opening region of the pixel structure.

Specifically, the first voltage is applied between the first electrode 521 and the second electrode 522 until the electronic ink 51 fills the accommodating space of the package device in a direction parallel to the first substrate 1 under the driving of the voltage between the first electrode 521 and the second electrode 522.

Further, the method may further include the following steps:

A second voltage is applied to the light blocking switching member 5, so that the display panel is switched from the dark state to the non-dark state, the light blocking switching member 5 may no longer shield the open region of the pixel structure.

Specifically, the second voltage is applied between the first electrode 521 and the second electrode 522 until the electronic ink 51 is collected in the region of the accommodating space corresponding to the black matrix 41.

The embodiment of the present disclosure provides the light blocking switching member 5 between the base substrate 21 and the thin film transistor 22 of the second substrate (array substrate) 2. When the image needs to be normally displayed, the light blocking switching member 5 is in a first state, and the electronic ink 51 in the light blocking switching member 5 is collected in the region corresponding to the black matrix under the control of the voltage between the first electrode 521 and the second electrode 522. When a black image is displayed, the light blocking switching member 5 is in a second state, and the electronic ink 51 fills the whole package device in the direction parallel to the array substrate 2 to prevent the light emitted from the backlight from being transmitted, and even if the liquid crystal display panel is pressed by an external force to change the orientation of the liquid crystal molecules, the light may be effectively blocked, thereby effectively solving the problem of dark state light leakage.

It is to be understood that the above embodiments are merely exemplary embodiments employed to explain the principles of the present disclosure, but the present disclosure is not limited thereto. Various modifications and improvements can be made by those skilled in the art without departing from the spirit and essence of the disclosure, and such modifications and improvements are also considered to be within the scope of the disclosure.

1. A pixel structure comprising a first substrate and a second substrate, the pixel structure being used for a display panel, wherein,
the pixel structure further comprises a light blocking switching member that covers an opening region of the pixel structure,
wherein the light blocking switching member is configured to switch between a first state and a second state, such that in the first state light is allowed to pass through the light blocking switching member so as to enter the opening region, and in the second state the opening region of the pixel structure is shielded by the light blocking switching member.

2. The pixel structure of claim 1, wherein the light blocking switching member is configured to be in the first state in response to a non-dark state of the display panel, and to shield the opening region of the pixel structure be in the second state in response to a dark state of the display panel.

3. The pixel structure of claim 2, wherein the light blocking switching member switches between the first state and the second state by applying a voltage to the light blocking switching member.

4. The pixel structure of claim 3, wherein the light blocking switching member comprises an electronic ink and a package device, the package device comprising a first electrode and a second electrode spaced apart from each other in a direction parallel to the first substrate or the second substrate, and the electronic ink being encapsulated within the package device and disposed between the first electrode and the second electrode,
wherein the electronic ink is capable of changing position within the package device under the action of a voltage applied between the first electrode and the second electrode.

5. The pixel structure of claim 4, wherein the light blocking switching member switches between the first state and the second state by applying the voltage between the first electrode and the second electrode, wherein in the first state, the electronic ink is collected at an edge of the package device such that an orthographic projection of the electronic ink on the first substrate or the second substrate is smaller than an orthographic projection of an inner surface of the package device parallel to the first substrate or the second substrate, and in the second state, the electronic ink is dispersed within the package device in a direction parallel to the first substrate or the second substrate in a such that the orthographic projection of an inner surface of the package device parallel to the first substrate or the second substrate on the first substrate or the second substrate.

6. The pixel structure of claim 5, wherein the package device further comprises a third electrode and a fourth electrode spaced apart from each other in a direction perpendicular to the first substrate or the second substrate; and
the light blocking switching member is configured such that, in a process of switching from the first state to the second state, the electronic ink is evenly distributed on the inner surface of the package device parallel to the first substrate or the second substrate by applying a voltage between the third electrode and the fourth electrode.

7. The pixel structure of claim 5, wherein the package device further comprises a third electrode and a fourth electrode spaced apart from each other in a direction perpendicular to the first substrate or the second substrate; and
the light blocking switching member is configured such that, in a process of switching from the first state to the second state, a voltage applied between the third electrode and the fourth electrode is zero.

8. The pixel structure of claim 5, further comprising a liquid crystal layer between the first substrate and the second substrate, and a black matrix on a side of the first substrate adjacent to the liquid crystal layer;
wherein the electronic ink is collected in a region within the package device corresponding to the black matrix in the first state.

9. The pixel structure of claim 6, wherein both the third electrode and the fourth electrode are transparent electrodes.

10. The pixel structure of claim 1, wherein the second substrate further comprises a base substrate and a thin film transistor, the light blocking switching member being located between the thin film transistor and the base substrate.

11. The pixel structure of claim 1, wherein a color filter is provided on a region of the first substrate corresponding to the opening region of the pixel structure.

12. A display panel comprising a plurality of the pixel structures of claim 1.

13. A driving method for driving the pixel structure of claim 1, comprising:
switching the light blocking switching member to the first state in response to a non-dark state of the display panel; and
switching the light blocking switching member to the second state in response to a dark state of the display panel.

14. The driving method of claim 13, wherein a voltage is applied to the light blocking switching member such that the light blocking switching member switches between the first state and the second state.

15. The driving method of claim 14, wherein the light blocking switching member comprises an electronic ink and a package device, the package device comprising a first electrode and a second electrode spaced apart from each other in a direction parallel to the first substrate or the second substrate, and the electronic ink being encapsulated within the package device and disposed between the first electrode and the second electrode, and
the voltage is applied between the first electrode and the second electrode such that the light blocking switching member switches between the first state and the and the second state, wherein in the first state, the electronic ink is collected at an edge of the package device such that an orthographic projection of the electronic ink on the first substrate or the second substrate is smaller than an orthographic projection of an inner surface of the package device parallel to the first substrate or the second substrate on the first substrate or the second substrate, and in the second state, the electronic ink is distributed in the package device in a direction parallel to the first substrate or the second substrate such that the orthographic projection of the electronic ink on the first substrate or the second substrate coincides with the orthographic projection of the inner surface of the package device parallel to the first substrate or the second substrate on the first substrate or the second substrate occupies the surface.

16. The driving method of claim 15, wherein the package device further comprises a third electrode and a fourth electrode spaced apart from each other in a direction perpendicular to the first substrate or the second substrate, and
in a process of switching the light blocking switching member from the first state to the second state, the electronic ink is evenly distributed on an inner surface of the package device parallel to the first substrate or the second substrate by applying a voltage between the third electrode and the fourth electrode.

17. The pixel structure of claim 4, wherein the electronic ink comprises a plurality of charged particles with the same electric property.

18. The pixel structure of claim 4, wherein the electronic ink comprises a black and opaque ink.

19. The pixel structure of claim 6, further comprising a liquid crystal layer between the first substrate and the second substrate, and a black matrix on a side of the first substrate adjacent to the liquid crystal layer;
wherein the electronic ink is collected in a region within the package device corresponding to the black matrix in the first state.

20. The pixel structure of claim 7, further comprising a liquid crystal layer between the first substrate and the second substrate, and a black matrix on a side of the first substrate adjacent to the liquid crystal layer;
wherein the electronic ink is collected in a region within the package device corresponding to the black matrix in the first state.
